(19) United States
(12) Patent Application Publication
(10) Pub. No.: US 2007/0030565 A1
(43) Pub. Date: Feb. 8, 2007

(54) Cross-Slide Stage And Microscope System Having A Cross-Slide Stage

(76) Inventors: Peter Soppelsa, Rebstein (CH); Vui Fah Loh, Singapore (SG)

Correspondence Address: HODGSON RUSS LLP, ONE M & T PLAZA, SUITE 2000, BUFFALO, NY, 14203-2391, US

(21) Appl. No.: 11/460,168

(22) Filed: Jul. 26, 2006

(30) Foreign Application Priority Data
Aug. 2, 2005 (DE) 10 2005 036 231.1

(51) Int. Cl. G02B 21/06

(52) U.S. Cl. 359/385; 359/393

(57) ABSTRACT

A cross-slide stage comprises a support element, a first displacement element (21) joined to the support element, and a second displacement element (31), wherein the displacement elements (21, 31) are movable in directions arranged perpendicular to one another. The second displacement element (31) defines a plane on which a specimen (105) to be investigated comes to rest. An illumination module (3a) is provided which defines an illuminated-field plane; and when the cross-slide stage (101) is placed onto the illumination module (3a), the plane of the second displacement element (31) coincides with the illuminated-field plane of the illumination module (3a).

### CROSS REFERENCE TO RELATED APPLICATIONS

This application claims priority of German patent application no. 10 2005 036 231.1 filed Aug. 2, 2005, which is incorporated by reference herein.

### FIELD OF THE INVENTION

The invention relates to a cross-slide stage for a microscope. The invention relates in particular to a cross-slide stage that comprises a support element, a first displacement element joined to the support element, and a second displacement element, wherein both displacement elements are movable in one plane in directions arranged perpendicular to one another; and the second displacement element defines a plane on which a specimen to be investigated comes to rest.

The invention furthermore relates to a microscope system having a cross-slide stage. The invention relates in particular to a microscope system having a cross-slide stage, the microscope system encompassing a microscope that is mounted on a stand. The stand is embodied with a transmitted-light base that is equipped with an illumination module for illumination of a specimen. Provided on the transmitted-light base is a cross-slide stage that comprises a support element, a first displacement element joined to the support element, and a second displacement element, wherein the displacement elements are movable in directions arranged perpendicular to one another; and the second displacement element defines a plane on which a specimen to be investigated comes to rest.

### BACKGROUND OF THE INVENTION

U.S. Patent Application 2003/0234979 A1 describes a stage that is characterized by three layers, the lowest of which is U-shaped and serves as carrier for the stage and has an upper surface that comprises guides for the center layer to enable a Y motion of the center layer. The center layer is a closed rectangle and likewise comprises guides for the X motion of the upper layer. The stage thus comprises four guides that are all implemented in this unit. It is additionally disadvantageous is that because of the physical height of the stage, the illuminated-field plane generated by the illumination device does not coincide with the surface of the cross-slide stage when the stage is placed onto the transmitted-light base. The acquisition of morphological and functional data from a living sample using a microscope system is made difficult because the illuminated-field plane no longer coincides with the stage surface, and both the illumination coverage of the specimen and the illumination aperture lie outside that plane.

U.S. Pat. No. 6,788,457 presents a stage for one-dimensional displacement that comprises only one guide along the direction of motion. In this arrangement the stage plate is supported on a baseplate, on a side located opposite the guide, at only one point. This stage, too, comprises a guide, and a baseplate for supporting the stage plate, that are implemented in one unit. The single-point mounting of the one side of the stage furthermore creates the risk of tilting of the stage surface when loaded at the corners.

According to this existing art, only arrangements in which two plates are arranged above the horizontal part of the illumination module are known; this results in a greater physical height as compared with an arrangement having a fixed stage. Adjustable stages are constituted as a unit made up of carriers, adjustable flat plates, and guidance elements.

### SUMMARY OF THE INVENTION

It is the object of the invention to create a cross-slide stage that is ergonomically favorable. A further intention is for the physical height of the cross-slide stage, when in place, to avoid any ergonomically unfavorable increase in viewing height.

A further object of the invention is to create a microscope system having a cross-slide stage such that optimal illumination coverage of the specimen exists, and such that any ergonomically unfavorable increase in viewing height as a result of a cross-slide stage placed onto a transmitted-light base is avoided.

A cross-slide stage according to the present invention has the advantage that the illuminated-field plane defined by the illumination device or illumination module coincides with the surface of the cross-slide stage. With the cross-slide stage according to the present invention used in a microscope system, it is possible to acquire morphological and functional data from a living specimen, since the illuminated field diaphragm coincides with the stage surface and illumination coverage of the specimen is thus optimized. In addition, specimen manipulation is not disadvantageously influenced by the use of the cross-slide stage according to the present invention. It is advantageous if the cross-slide stage is constructed from three elements. The cross-slide stage comprises on the one hand a support element, a first displacement element joined to the support element, and a second displacement element. The two displacement elements are embodied displaceably with respect to one another within one plane, in spatial directions arranged perpendicularly to one another. In addition, the second displacement element defines a plane on which a specimen to be investigated comes to rest. The cross-slide stage is placed onto an illumination module that defines an illuminated-field plane. The entire cross-slide stage is configured in such a way that the plane of the second displacement element coincides with the illuminated-field plane of the illumination module.

The illumination module is embodied as a transmitted-light base. It produces an illuminated-field plane, and has an elevation having a plane parallel to the illuminated-field plane and at a short distance therebelow, the plane of the elevation serving as a guide for the second displacement element of the cross-slide stage.

The first displacement element and the support element are embodied in such a way that they partially surround the elevation of the illumination module. In an advantageous embodiment, the first displacement element and the support element are U-shaped. Multiple mounting points are embodied around the illumination module and around the elevation, and are likewise arranged in a plane parallel to the illuminated-field plane. The U-shaped support element is mounted on the mounting points.

The cross-slide stage can be moved in the various spatial directions by drive knobs. The spatial directions are advantageously the X coordinate direction and the Y coordinate direction. One drive knob is provided for each of the coordinate directions. The first drive knob drives a pinion that engages into a toothed rack that is mounted on the support element. Guidance elements are arranged between the support element and the first displacement element. The second drive knob drives, by means of a cable spool and a cable via a deflection pulley, a block that itself is coupled to the second displacement element, so that a motion in the X coordinate direction is thereby executed.

It is furthermore advantageous to use the cross-slide stage according to the present invention in a microscope system, the microscope system encompassing a microscope that is mounted on a stand. The stand is embodied with a transmitted-light base that possesses an illumination module for illumination of a specimen. The cross-slide stage, which comprises a support element and a first displacement joined to the support element, and a second displacement element, is provided on the transmitted-light base. The two displacement elements are movable within one plane in spatial directions arranged perpendicular to one another. The second displacement element defines a plane on which a specimen to be investigated comes to rest. The illumination module itself defines an illuminated-field plane, the second displacement element coinciding with the illuminated-field plane of the illumination module of the cross-slide stage when the cross-slide stage is in place.

The microscope used in the microscope system is a stereomicroscope. The cross-slide stage can also be configured exchangeably so that it can be replaced by a fixed stage, in which context the spacing from a main objective of the stereomicroscope remains the same.

Further advantageous embodiments of the invention may be gathered from the dependent claims.

### BRIEF DESCRIPTION OF THE DRAWINGS

The subject matter of the invention is depicted schematically in the drawings and will be described below with reference to the Figures, in which:

FIG. 1 is a schematic side view of a microscope system having the cross-slide stage according to the present invention;

FIG. 2 shows an embodiment of the transmitted-light base, and an exploded depiction of the elements of the cross-slide stage that is placed onto the transmitted-light base;

FIG. 3 is a cross-section through the transmitted-light base with the cross-slide stage according to the present invention put in place, and with schematically indicated illumination; and

FIG. 4 shows in detail the guidance and drive principles of the cross-slide stage.

### DETAILED DESCRIPTION OF THE INVENTION

In the description that follows, microscope system 100 encompasses a stereomicroscope. This is in no way to be construed as a limitation.

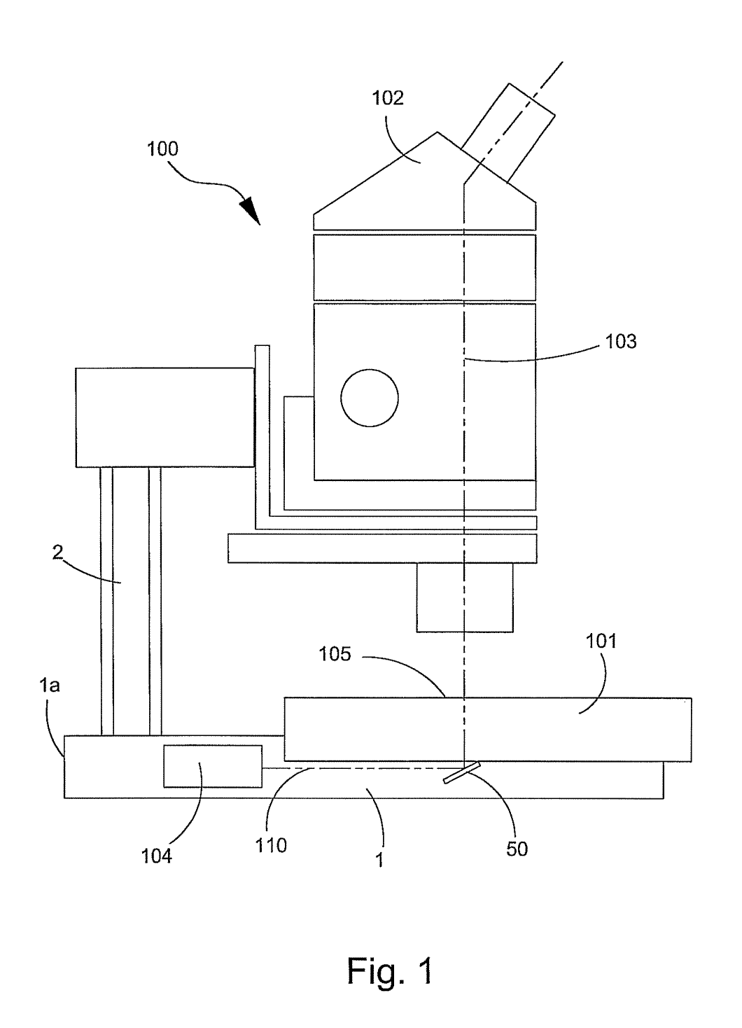

FIG. 1 is a schematic side view of a microscope system 100 having cross-slide stage 101 according to the present invention. Cross-slide stage 101 is placed onto a transmitted-light base 1. Mounted at rear end 1a of transmitted-light base 1 is a column 2 along which microscope 102 of microscope system 100 can be displaced in the direction of an optical axis 103. Transmitted-light base 1 can contain an illumination device 104 that emits light 110 in the direction of optical axis 103 of microscope 102. The transmitted-light base includes a deflection element 50 that deflects in the direction of optical axis 103 the light emitted from light source 104. It is likewise conceivable for the light for transmitted-light illumination to be generated by an external light source and delivered via a flexible light guide to microscope system 100 or optical axis 103 of the microscope. Specimen 105 to be observed lies on cross-slide stage 101.

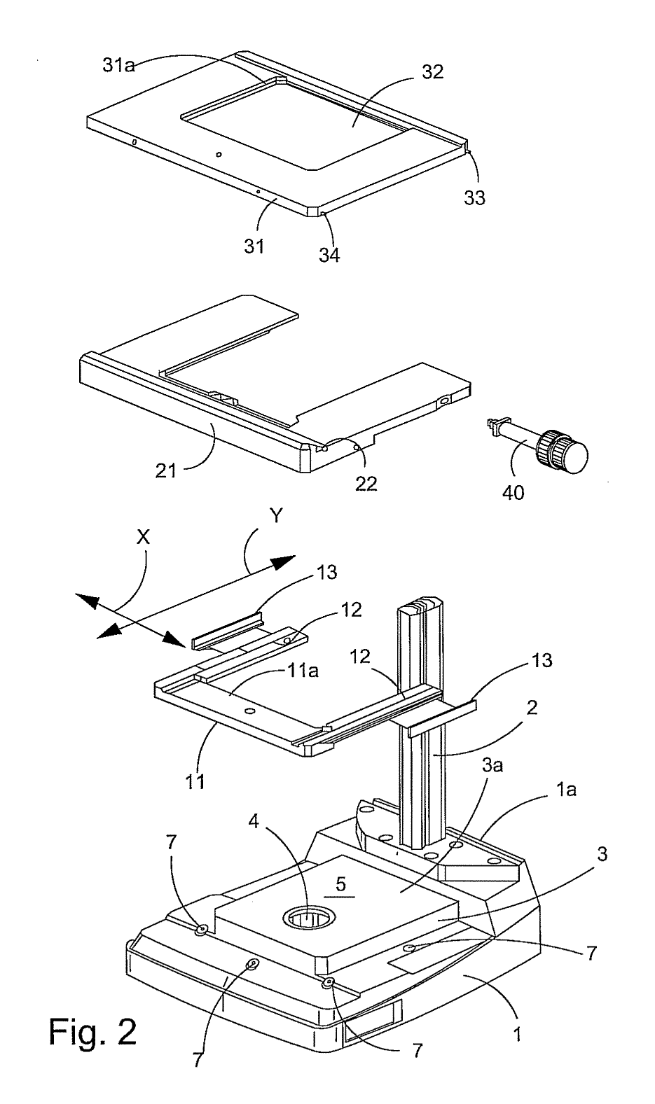

FIG. 2 shows a transmitted-light base 1 according to an embodiment of the invention. As already mentioned, a column 2, along which focusing of microscope 102 takes place in known fashion, is mounted at rear end 1a of transmitted-light base 1. Transmitted-light base 1 is embodied with an elevation 3 having a planar top surface 5 that represents an upper boundary of illumination module 3a. Illumination module 3a is embodied with a light exit opening 4 through which the light generated by the illumination device travels onto specimen 105. Light exit opening 4 ends below an illuminated-field plane with which illumination module 3a is embodied. Illumination module 3a is closed off at the top by a plane of top surface 5 of elevation 3 that is arranged parallel to the illuminated-field plane at a small distance therebelow. Top surface 5 of elevation 3 serves as a guide for second displacement element 31 of cross-slide stage 101. The illuminated-field plane is perpendicular to optical axis 103 of microscope system 100 or microscope 102. Multiple mounting points 7 are arranged in one plane next to elevation 3 on transmitted-light base 1. Mounting points 7 serve for installation of a support element 11 on transmitted-light base 1. On upper side 11a of support element 11, two guides 12 are embodied in the Y coordinate direction. These guides coact with a first displacement element 21. Support element 11 additionally has a respective toothed rack 13 installed on it parallel to each guide 12. Toothed rack 13 coacts with a functional group 40 that is provided for moving first displacement element 21 and second displacement element 31. Second displacement element 21 is likewise embodied with a guide 22 that constitutes a guide in the X coordinate direction for second displacement element 31. Second displacement element 31 is equipped with a cylindrical slide element 33 that is braced, in the region of column 2, directly on top surface 5 of illumination module 3a. Second displacement element 31 is embodied with a portion 31a in which a transparent plate 32 comes to rest. Transparent plate 32 can also be replaced by a heating stage, a rotary stage, Petri dishes, microtitration plates, and the like. It is likewise possible to provide devices for micromanipulation on cross-slide stage 101. Displacement of first displacement element 21 in the Y coordinate direction with respect to the stationary support element 11, and displacement of second displacement element 31 in the X coordinate direction with respect to first displacement element 21, result in a displacement of specimen 105 in the X/Y plane. The X/Y plane is parallel to the illuminated-field plane and to the plane of top surface 5 of elevation 3 of illumination module 3a, which plane is defined by elevation 3 of illumination module 3a. First displacement element 21 and support element 11 are embodied in such a way that they partially surround elevation 3 of illumination module 3a. In a particularly preferred embodiment, first displacement element 21 and support element 11 are U-shaped.

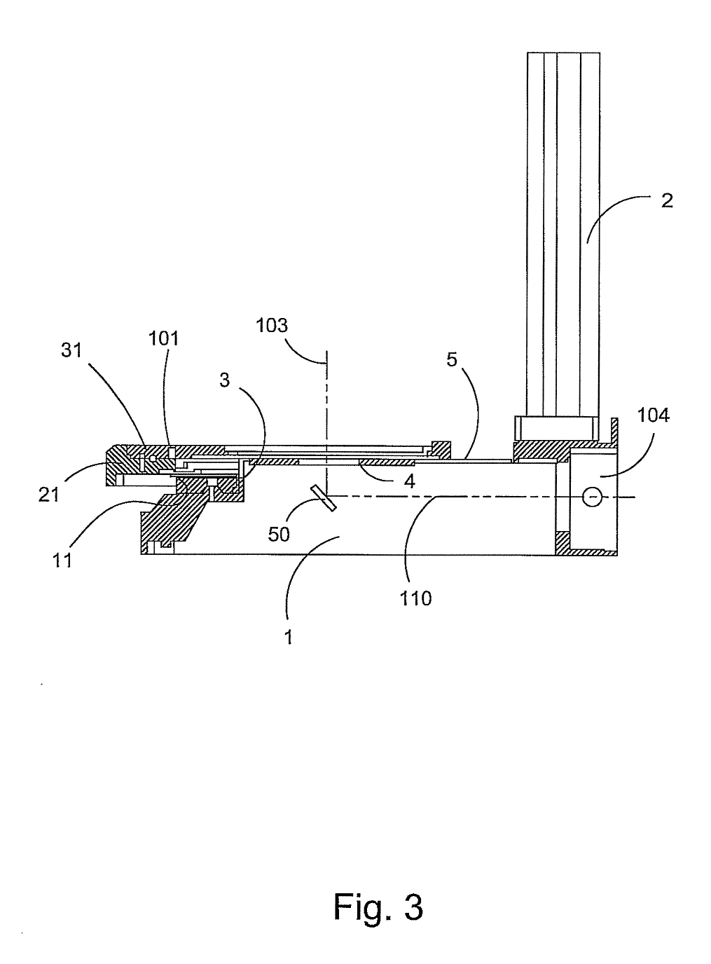

FIG. 3 is a detail view of a cross section through transmitted-light base 1 and through cross-slide stage 101 placed on transmitted-light base 1. Mounted on transmitted-light base 1 is an illumination device 104 that sends light 110 into transmitted-light base 1 to illuminate specimen 105. A deflection element 50, which deflects light 110 of illumination device 104 in the direction of optical axis 103, is provided in transmitted-light base 1. FIG. 3 clearly shows the arrangement according to the present invention of cross-slide stage 101, second displacement element 31 being displaceable in the X coordinate direction and Y coordinate direction on plane 5 defined by elevation 3. All the other elements of cross-slide stage 101 (first displacement element 21 and support element 11) are arranged with their planes below plane 5.

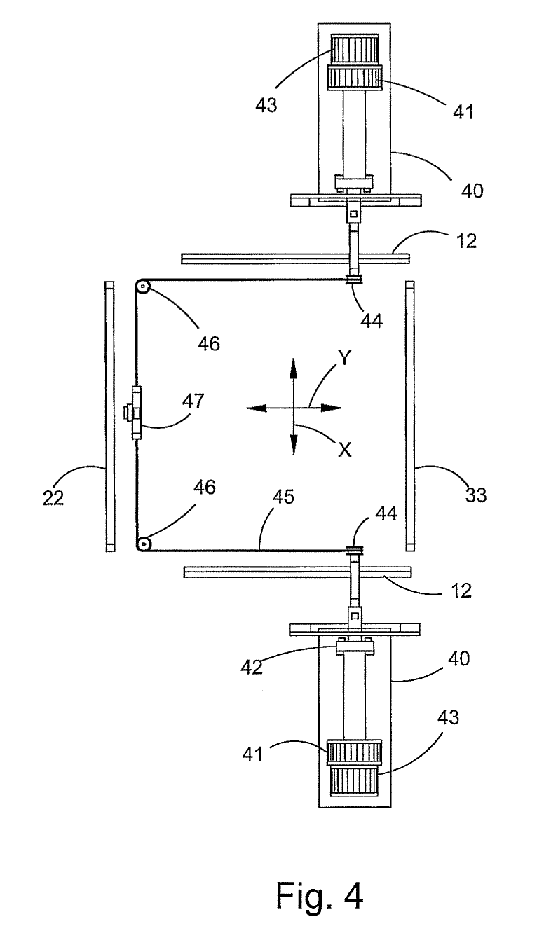

FIG. 4 shows in detail how cross-slide stage 101 according to the present invention is driven. Functional group 40, provided for driving cross-slide stage 101 in the X coordinate direction and Y coordinate direction, comprises a first drive knob 41 and a second drive knob 43. First drive knob 41 serves to move cross-slide stage 101 in the Y coordinate direction. Second drive knob 43 serves to move cross-slide stage 101 in the X coordinate direction. First drive knob 41 and second drive knob 43 are arranged coaxially. A pinion 42, which engages into toothed rack 13 on support element 11, is driven with first drive knob 41. Upon rotation of pinion 42, first displacement element 21 is moved along guidance elements 12 in the Y coordinate direction. FIG. 4 also shows that functional group 40 can likewise be placed on the opposite side of cross-slide stage 101 in order to drive the cross-slide stage in the X coordinate direction and Y coordinate direction. Both left-handed and right-handed operation of cross-slide stage 101 is thus possible for the user of microscope system 100. Left-handed operation of cross-slide stage 101 is represented by functional group 40 depicted in FIG. 4. Second drive knob 43 drives a cable spool 44 that winds and unwinds a cable 45. the cable 45 is deflected by deflection pulleys 46 to provide a cable portion extending in the X axis direction and having a block 47 fixed thereto. The block, which moves along an X axis direction when cable 45 is wound or unwound, is coupled to second displacement element 31 to drive the second displacement element. The guidance elements for moving second displacement element 31 in the X coordinate direction are on the one hand the cylindrical slide element 33 that rests on plane 5, and a further cylindrical slide element 34 that rests in guide 22 of first displacement element 21.

Because the drive embodiment described above has no self-locking function, second displacement element 31 can be adjusted in both coordinate directions both in precise fashion with functional group 40, and rapidly by manual application of a force.

A friction wheel and a rail can also be used instead of a pinion 42 and a toothed rack 13.

Although only manual adjustment of the cross-slide stage is depicted, the invention is not limited thereto. A motorized drive system can also be provided.

The invention has been described with reference to a particular embodiment. It is self-evident, however, that changes and modifications can be made without thereby leaving the range of protection of the claims below.

What is claimed is:

1. An apparatus comprising:
an illumination module defining an illuminated-field plane,
a cross-slide stage placed on the illumination module, the cross-slide stage including a support element, a first displacement element coupled to the support element and movable relative to the support element along a first axis, and a second displacement element coupled to the first displacement element and movable relative to the first displacement element along a second axis perpendicular to the first axis, the second displacement element defining a specimen plane on which a specimen rests;
wherein the specimen plane coincides with the illuminated-field plane when the cross-slide stage is placed on the illumination module.

2. The apparatus according to claim 1, wherein the illumination module is a transmitted-light base.

3. The apparatus according to claim 1, wherein the illumination module includes an elevation having a planar top surface parallel to the illuminated-field plane and just below the illuminated-field plane, the top surface serving as a guide for the second displacement element of the cross-slide stage.

4. The apparatus according to claim 3, wherein the first displacement element and the support element of the cross-slide stage at least partially surround the elevation of the illumination module.

5. The apparatus according to claim 4, wherein the first displacement element and the support element are U-shaped.

6. The apparatus according to claim 3, wherein the illumination module includes a plurality of mounting points in a plane parallel to and below the illuminated-field plane, and the support element is mounted on the mounting points.

7. The apparatus according to claim 1, wherein the second displacement element includes a cylindrical slide element resting on the top surface of the elevation.

8. The apparatus according to claim 1, wherein the second displacement element includes an exchangeable transparent plate.

9. The apparatus according to claim 1, further comprising a first drive knob and a second drive knob coaxial with the first drive knob, the first drive knob being connected to the first displacement element for moving the first displacement element along the first axis, and the second drive knob being connected to the second displacement element for moving the second displacement element along the second axis.

10. The apparatus according to claim 9, wherein the first and second drive knobs are mounted on the first displacement element.

11. The apparatus according to claim 9, wherein the first drive knob drives a pinion that engages a toothed rack fixed to the support element to move the first displacement element along the first axis, wherein guidance elements are arranged between the support element and the first displacement element for guiding motion along the first axis; and the second drive knob drives a cable spool to wind and unwind a cable, wherein the cable is deflected by a pair of deflection pulleys to provide a cable portion extending in a direction of the second axis and having a block fixed thereto, the block being coupled to the second displacement element to move the second displacement element along the second axis.

12. The apparatus according to claim 11, wherein the illumination module includes an elevation having a planar top surface parallel to the illuminated-field plane and just below the illuminated-field plane; and wherein the second displacement element includes a first cylindrical slide element resting on the top surface of the elevation and a second cylindrical slide element resting in a guide slot provided on the first displacement element.

13. The apparatus according to claim 1, further comprising a fixed stage having the same height as the cross-slide stage, wherein the cross-slide stage is exchangeable with the fixed stage.

14. A microscope system comprising:
a stand including a transmitted-light base, the transmitted-light base having an illumination module for illumination of a specimen, wherein the illumination module defines an illuminated-field plane;
a microscope mounted on the stand; and
a cross-slide stage placed on the illumination module of the transmitted-light base, the cross-slide stage including a support element, a first displacement element coupled to the support element and movable relative to the support element along a first axis, and a second displacement element coupled to the first displacement element and movable relative to the first displacement element along a second axis perpendicular to the first axis, the second displacement element defining a specimen plane on which a specimen rests;
wherein the specimen plane coincides with the illuminated-field plane when the cross-slide stage is placed on the illumination module.

15. The microscope system according to claim 14, wherein the illumination module includes an elevation having a planar top surface parallel to the illuminated-field plane and just below the illuminated-field plane, the top surface serving as a guide for the second displacement element of the cross-slide stage.

16. The microscope system according to claim 14, wherein the first displacement element and the support element of the cross-slide stage at least partially surround the elevation of the illumination module.

17. The microscope system according to claim 16, wherein the first displacement element and the support element are U-shaped.

18. The microscope system according to claim 14, wherein the transmitted-light base includes a plurality of mounting points arranged around the illumination module in a plane parallel to the illuminated-field plane, and the support element is mounted on the mounting points.

19. The microscope system according to claim 14, wherein the second displacement element includes a cylindrical slide element resting on the top surface of the elevation.

20. The microscope system according to claim 14, wherein the second displacement element includes an exchangeable transparent plate.

21. The microscope system according to claim 14, further comprising a first drive knob and a second drive knob coaxial with the first drive knob, the first drive knob being connected to the first displacement element for moving the first displacement element along the first axis, and the second drive knob being connected to the second displacement element for moving the second displacement element along the second axis.

22. The microscope system according to claim 21, wherein the first and second drive knobs are mounted on the first displacement element.

23. The microscope system according to claim 21, wherein the first drive knob drives a pinion that engages a toothed rack fixed to the support element to move the first displacement element along the first axis, wherein guidance elements are arranged between the support element and the first displacement element for guiding motion along the first axis; and the second drive knob drives a cable spool to wind and unwind a cable, wherein the cable is deflected by a pair of deflection pulleys to provide a cable portion extending in a direction of the second axis and having a block fixed thereto, the block being coupled to the second displacement element to move the second displacement element along the second axis.

24. The microscope system according to claim 21, wherein the first drive knob drives a friction wheel that rolls on a rail fixed to the support element to move the first displacement element along the first axis, wherein guidance elements are arranged between the support element and the first displacement element for guiding motion along the first axis; and the second drive knob drives a cable spool to wind and unwind a cable, wherein the cable is deflected by a pair of deflection pulleys to provide a cable portion extending in a direction of the second axis and having a block fixed thereto, the block being coupled to the second displacement element to move the second displacement element along the second axis.

25. The microscope system according to claim 21, wherein the second displacement element includes a first cylindrical slide element resting on the top surface of the elevation and a second cylindrical slide element resting in a guide slot provided on the first displacement element.

26. The microscope system according to claim 14, wherein the microscope is a stereomicroscope.

27. The microscope system according to claim 26, further comprising a fixed stage having the same height as the cross-slide stage, wherein the cross-slide stage is exchangeable with the fixed stage.

28. The microscope system according to claim 14, wherein the support element is integral with the transmitted-light base.
